(19) United States
(12) Patent Application Publication
(10) Pub. No.: US 2023/0281510 A1
(43) Pub. Date: Sep. 7, 2023

(54) MACHINE LEARNING MODEL ARCHITECTURE COMBINING MIXTURE OF EXPERTS AND MODEL ENSEMBLING

(71) Applicant: QUALCOMM Incorporated, San Diego, CA (US)

(72) Inventors: Amelie Marie Estelle ROYER, Amsterdam (NL); Ilia KARMANOV, Amsterdam (NL); Andrii SKLIAR, Diemen (NL); Babak EHTESHAMI BEJNORDI, Amsterdam (NL); Tijmen Pieter Frederik BLANKEVOORT, Amsterdam (NL)

(21) Appl. No.: 18/154,429

(22) Filed: Jan. 13, 2023

Related U.S. Application Data
(60) Provisional application No. 63/317,236, filed on Mar. 7, 2022.

(51) Int. Cl. G06N 20/00

(52) U.S. Cl. CPC G06N 20/00

(57) ABSTRACT

Certain aspects of the present disclosure provide techniques and apparatus for machine learning. In one aspect, base model output data is generated, the generating including processing input data with at least a portion of a base model of a machine learning model architecture, and the base model output data is processed with a routing model of the machine learning model architecture in order to determine a selected expert model, of a plurality of expert models, with which to process the base model output data. Expert model output data is generated, where generating the expert model output data includes processing the base model output data with the selected expert model, and final output data from the machine learning model architecture is generated, where generating the final output data includes processing the base model output data and the expert model output data with an ensemble model of the machine learning model architecture.

### CROSS REFERENCE TO RELATED APPLICATIONS

This application claims priority to U.S. Provisional Pat. Application No. 63/317,236, filed Mar. 7, 2022, the entire contents of which are incorporated herein by reference.

### INTRODUCTION

Aspects of the present disclosure relate to machine learning model architectures combining mixture of experts and model ensembling.

Mixture of experts (MoE) is a form of conditional computing architecture for machine learning models that allows for processing relevant portions of a model architecture while bypassing unnecessary portions of the model architecture. In particular, sparse MoE models dynamically select which parameters of the network to use, conditioned on the input. Compared to dense models, sparse MoE models can vastly expand their number of parameters and improve performance, while keeping the computation costs per input similar.

However, while there are some approaches for training extremely large-scale MoE models (e.g., with greater than 100 billion parameters), there are not presently effective methods for training small and efficient MoE models. Consequently, MoE models are generally not amenable to use on resource-constrained devices, including mobile devices, edge processing devices, always-on devices, Internet of things (IoT) devices, and the like.

Accordingly, efficient and high performance MoE frameworks that can be executed on a wider variety of devices, including resource-constrained devices, are desired.

### BRIEF SUMMARY

Certain aspects provide a computer-implemented method that includes generating base model output data, the generating including processing input data with at least a portion of a base model of a machine learning model architecture; processing the base model output data with a routing model of the machine learning model architecture in order to determine a selected expert model, of a plurality of expert models, with which to process the base model output data; generating expert model output data, wherein generating the expert model output data includes processing the base model output data with the selected expert model; and generating final output data from the machine learning model architecture, wherein generating the final output includes processing the base model output data and the expert model output data with an ensemble model of the machine learning model architecture.

Certain aspects provide a computer-implemented method for training a machine learning model architecture, including training a base model comprising a plurality of layers using a training data set; performing clustering on features output from an intermediate layer, of the plurality of layers, to generate a plurality of training data subsets; training each respective expert model of a plurality of expert models on a respective training data subset of the plurality of training data subsets; training a router model to route training data samples among the plurality of expert models; and training an ensemble model to generate machine learning model architecture output data based on base model output data generated by the base model and expert model output data generated by one or more of the plurality of expert models.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example mixture of expert model architecture with model ensembling.

FIG. 2 depicts an example of processing input data with the architecture described with respect to FIG. 1.

FIG. 3 depicts another example of processing input data with the architecture described with respect to FIG. 1.

FIG. 4 depicts another example of processing input data with the architecture described with respect to FIG. 1.

FIG. 5 is a flow diagram depicting an example method to process data using a model architecture.

FIG. 6 is a flow diagram depicting an example inferencing method.

FIG. 7 is a flow diagram depicting an example training method.

FIG. 8 depicts an example processing system configured to perform the various methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for training and inferencing with mixture of expert model architectures that include model ensembling.

At least some conventional convolutional neural networks systematically execute all neuron-to-neuron connections for any given input. This conventional processing technique is often inefficient, however, because not all features are relevant for every situation. For instance, if an image does not contain a human, then the features that specialized in distinguishing baby humans from adult humans may not be relevant to the model’s inference (e.g., a classification) and thus could be turned off or unused. Similarly, images have varying levels of complexity, ranging from simple cases such as a single object on a white background to images with much more clutter and difficult camera angles. In order to imbue networks with the capacity to exploit these natural phenomena, conditional computing and early exiting have been explored.

In conditional computing, subparts of the network are turned on or off dynamically based on the input data. In early exiting, similar conditional behavior applies, but across the depth/complexity dimension. In the former case, the prediction can be finalized early on in the network thus preventing unnecessary computation, while in the latter, the full depth execution is used.

Mixture of experts (MoE) models can be used to provide conditional computing in transformer models. As a result, models with a large number of parameters but numerous sparse routing decisions can be used for natural language processing applications. In computer vision, similar models have emerged, introducing conditional routers in transformers applied to patches of images. Conditional computing has shown substantial promise on such large-scale transformer models, but has not been used with standard convolutional networks or for smaller datasets. However, many networks in commercial applications run on resource-constrained devices such as (but not limited to) mobile phones and low-compute IoT platforms. For this reason, lightweight convolutional networks, like MobileNetV3, remain very popular in practice because such networks can actually be executed on resource-constrained devices. Some attempts to integrate MoE models in convolutional networks suffer from a variety of issues, including training instabilities and lack of clarity on the benefits brought by the expert models with respect to the increased training cost.

Aspects described herein provide techniques for single-gate MoE models for enabling conditional computing in various types of machine learning models, including conventional convolutional neural networks, and for both small- and large-scale datasets. In particular, aspects described herein improve at least some conventional MoE frameworks with an additional regularization technique in which a selected expert is ensembled with a shared knowledge branch that is shared across the experts. In some aspects described herein, this shared knowledge branch can be exploited as an early exit point in the network, as well as by feeding the shared knowledge branch’s early features as inputs to the experts.

Some aspects described herein provide stable, asynchronous, training pipelines for single-gate MoE models that reach similar or better accuracies as other approaches (such as joint Expectation-Maximization training schemes) while allowing for significantly reduced complexity and expense during training. In particular, the single-gate design of hierarchical classification used in some aspects described herein allows for more efficient training (e.g., because experts can be trained more independently) and reduces the number of memory accesses for loading the computational path of any given sample.

Thus, aspects described herein improve on the state of the art in many ways. For example, some architectures described herein enable ensembling the predictions of a shared base model with the predictions of expert models, which can yield significant performance improvements over at least some conventional architectures. Further, some architectures described herein can enable early routing of samples to experts, which obviates fully executing the base model and saves computational expense. Additionally, some architectures described herein can enable early exiting for easy samples, which can be classified confidently without requiring an expert. The routing function for assigning experts to inputs, in some aspects described herein, performs per-sample routing, which outperforms class-based routing approaches. Additionally, the training schemes described herein for the gate and experts can address the instability issues of at least some conventional MoE models’ training schemes. Further, aspects described herein generally outperform state-of-the-art methods in the high efficiency compute domain. Beneficially, the efficient MoE architectures described herein may perform many types of machine learning tasks (e.g., image classification and recognition) with reduced computational complexity and expense, enabling the disclosed architectures to be used even on resource-constrained devices (e.g., mobile platforms).

### Introduction to Mixture of Experts Models

Conventional MoE architectures may be introduced in the context of image classification. Generally, an MoE architecture consists of a set of K experts, (eₖ)_{1...K}, each outputting a distribution over the set of target classes. The execution of the experts is conditioned by the outputs of a router, r, which outputs a probability distribution over the set of experts. The total likelihood of the model on the training dataset D, which is to be maximized, may thus be expressed as:

$${E}_{\left(x , y\right) \sim D} {\sum }_{k = 1}^{K} r \left(k \vert x\right) {e}_{k} \left(y \vert x\right) \qquad \text{(1)}$$

Conventional MoE architectures generally rely on the assumption that each expert specializes on a portion of the data, and that the mapping from a sample to the most relevant expert is easy to learn. However, at least some conventional MoE architectures suffer from two common issues: (1) experts may specialize excessively and start to overfit to their respective subset, which is particularly risky when targeting small datasets; and (2) learning the routing without supervision is non-trivial-the router/learning may easily collapse, effectively using only a few experts. Such router collapse is particularly detrimental when using small neural network architectures, as router collapse considerably reduces the parameter space.

Aspects described herein change the standard MoE architecture to alleviate these issues. First, aspects described herein introduce a shared knowledge branch (which may be referred to as a “base model” in some aspects). In an aspect, the base model is trained on the whole dataset D, and is used as a form of expert regularization through ensembling, as discussed in more detail below. While some previous works have ensembled specialized experts together in MoE models to boost accuracy, aspects described herein ensemble one expert with the non-specialist branch (from the base model), which can yield higher prediction accuracies. Further, some aspects described herein provide a more efficient training scheme that keeps the router and experts independent, which avoids router collapse (e.g., where one expert becomes the preferred expert merely by getting earlier training than the other experts).

In various aspects described herein, the base model may be a simple (and in some cases, lightweight) neural network model trained on the whole dataset, D, which is executed (at least in some portion) for all input samples. By ensembling the base model with a selected expert model, accuracy improves greatly. Further, in some aspects, the base model allows for an early exit at inference time when the base model prediction is confident, thus avoiding redundant expert computations for some (simpler) samples. In some aspects, output from early layers of the base model may be reused as inputs to the router and/or to the expert models, which allows reuse of computations and improved efficiency of the overall architecture.

In some aspects described herein, the router model r is a simple linear layer which takes, as input, the pre-logits of the base model. In other aspects, the router may correspond to other architectures, such as a multilayer perceptron (MLP), a convolutional neural network, a transformer, and the like. At training time, the router model outputs a probability distribution over experts, r (k|x), allowing for direct backpropagation through its weights. At inference time, in some aspects, the most probable expert model is selected for execution, e.g., rₜₑₛₜ(k|x) = [|argmaxₖ,r(k′|x)|]. In other aspects, a number of expert models may be selected rather than selecting the best (single) expert model.

In various aspects described herein, expert models are parametrized as neural networks whose input is an intermediate feature map generated by the base model. This can yield two benefits: (1) the expert models’ early features are shared and frozen, which reduces the number of trainable parameters in each and reduces the risk of experts overfitting (in particular when training on small datasets); and (2) this allows the expert models to reuse computations from the base model at inference time, further improving efficiency.

In some aspects described herein, an ensemble model is a (potentially shallow) neural network model. In some aspects, a single ensemble model is used to combine the outputs of the base model and the selected expert model. In other aspects, there may be one ensemble model for each expert model, where each expert-specific ensemble model combines the outputs of the base model and the corresponding expert. This combination of base model and expert model ensembling may be referred to as “ensembling models” in some aspects. For example, e′k(x) = dₖ(eₖ(x), ϕ(x)) may be referred to as the output of the ensemble model dₖ, which ensembles the k-th expert and base model ϕ.

According to various aspects, the architectures and techniques described herein may generally comprise one or more of: a shared knowledge branch (e.g., base model), one or more gate models to enable early exiting from the base model, a set of expert models that are specialized to a specific portion of the dataset, a router model for expert selection, and/or an ensemble model to combine the predictions of the generic base model and the selected expert model(s).

### Example Mixture of Experts Model Architecture With Model Ensembling

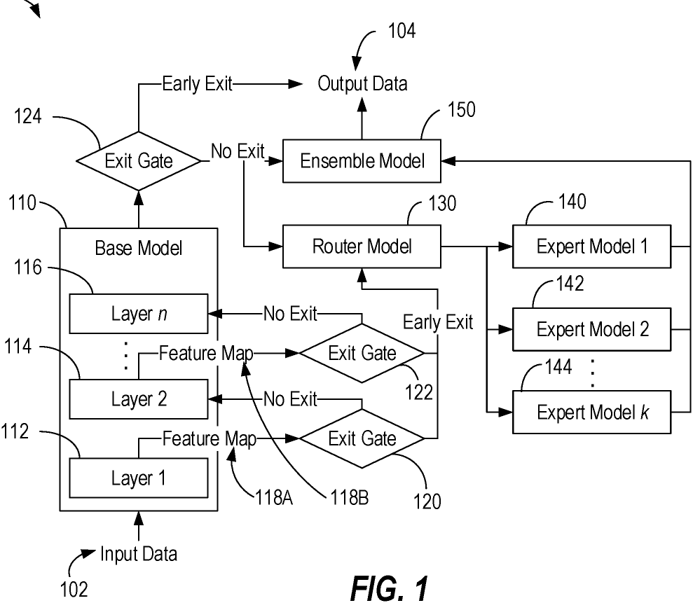

FIG. 1 depicts an example mixture of experts (MoE) model architecture 100 with model ensembling. In some aspects, the architecture 100 corresponds to, is part of, and/or is implemented by a machine learning system.

The architecture 100 includes a base model 110, which includes a number of layers 112, 114, and 116 (labeled as layers 1 through n in FIG. 1). Though three discrete layers 112, 114, and 116 are depicted for conceptual clarity, in aspects, there may be any number of layers in the base model 110. Generally, each of the layers of base model 110 may be, for example, one or more layers of a neural network model, such as (but not limited to) convolution layers, normalization layers (e.g., batch normalization), pooling layers (e.g., average, max, or min pooling), activation layers, attention layers, and the like. Base model 110 may form part of the so-called generic or shared knowledge branch of architecture 100. The architecture of the base model 110 may vary, depending on the particular implementation. In some aspects, the base model 110 is a (deep) convolutional neural network. In some aspects, the base model 110 is a transformer neural network.

Generally, in some aspects, the base model 110 may be trained on an entire training dataset. That is, while other components of the architecture 100 (e.g., the expert models) may each be trained on a subset of the exemplars available in the training dataset, the base model 110 may be trained on all such exemplars. As illustrated, input data 102 can be provided as input to the base model 110 to generate output (e.g., output data 104). As described further below, when the base model 110 is confident in its output (i.e., when the output of the base model 110 is associated or scored with sufficient confidence), the architecture 100 may optionally bypass the specialized expert models 140, 142, and/or 144 for accurate prediction, which reduces computational costs.

Further, in some aspects, features generated and/or output by one or more layers of base model 110 (e.g., from the final layer of the base model 110, the penultimate layer of base model 110, or from an intermediate/internal layer) may be used as input to router model 130 (also referred to as a routing model in some aspects) for expert selection. In some aspects, the prediction of base model 110 may be combined with the prediction of one or more selected expert models 140, 142, and/or 144 using ensemble model(s) 150 to improve task performance (e.g., classification, recognition, etc.). Generally, the particular architecture(s) of the expert models may vary depending on the particular implementation. For example, in some aspects, the expert models 140, 142, and/or 144 may comprise convolutional neural networks, transformer models, and the like.

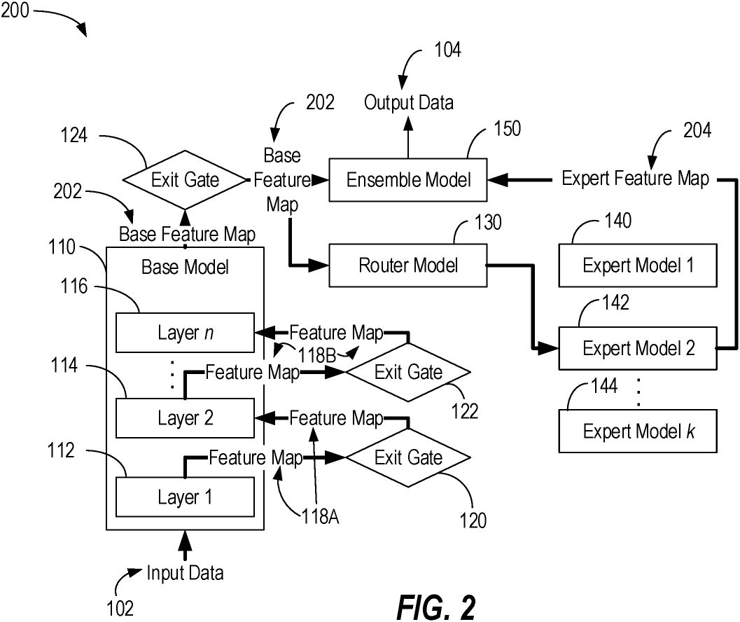

As illustrated, the architecture 100 further includes several early exit gate models 120, 122, and 124, which enable the architecture 100 to leverage the fact that not all samples of input data 102 involve equal effort or computational expense to process. For example, the early exit gate models 120 and 122 allow for early exiting from the base model 110 based on factors such as (but not limited to) the difficulty of a sample of the input data 102 and/or the prediction confidence of the base model 110. The early exit gate model 124 may enable bypass of ensemble model 150 and/or router model 130 and the expert models 140, 142, and 144. Generally, early exiting gate models 120, 122, and 124 can be implemented using a variety of techniques, including a simple threshold or a learned gate model. Various (non-limiting) early exiting scenarios are described with respect to FIGS. 2-4.

In some aspects, an early exit gate model (e.g., early exit gate models 120, 122, and/or 124) may be implemented using a single linear layer that takes, as an input, a flat (e.g., one-dimensional) vector, such as (but not limited to) a pre-logit. In alternative aspects, an early exit gate model may include additional layers, such as one or more convolutional layers, and may take as input multidimensional (e.g., 2D) feature maps. In such aspects, the additional layer(s) may reduce the multidimensional feature map to a flat vector for input into a linear layer. In some aspects, the early exit gate models comprise MLPs.

In some aspects, the early exit gate models 120 and 122 are configured to make a binary decision indicating whether to proceed to the router model 130 (e.g., to provide the input of the exit gate model as input to the router model 130) or not. Specifically, as illustrated, the early exit gate model 120 can evaluate intermediate feature map 118A (also referred to as “intermediate activation data” in some aspects) generated by the layer 112 of the base model 110 in order to determine whether to provide the intermediate feature map 118A as input to a subsequent layer of the base model 110 (e.g., to the layer 114) or to the router model 130. Similarly, the early exit gate model 122 can evaluate the intermediate feature map 118B generated by the layer 114 of the base model 110 in order to determine whether to provide the intermediate feature map 118B as input to a subsequent layer of the base model 110 (e.g., to the layer 116) or to the router model 130.

In some such cases, a small transformation model or layer (e.g., a small convolutional neural network) may be used to transform the intermediate feature map, output by a layer of the base model 110 and provided as input to the early exit gate model, into the appropriate “shape” or format of input used by router model 130.

In some aspects, early exiting gates that control exiting from intermediate layers of base model 110 (e.g., early exit gate models 120 and 122) may be referred to as “base model early exit gates.” Early exit gates that control bypassing of router model 130, expert models 140-144, and ensemble model 150 (e.g., early exit gate model 124) may be referred to as “expert model bypass gates.”

Although three early exit gate models 120, 122, and 124 are depicted for conceptual clarity, in aspects, there may be any number and variety of early exit gates in the architecture 100. In some aspects, each layer of the base model 110 has a corresponding early exit gate model. In other aspects, only a subset of the layers of the base model 110 may have exit gate models.

As illustrated, the architecture 100 further includes the router model 130. In some aspects, the router model r is parameterized by a neural network and takes, as input features, either the output of the final layer of base model 110 (e.g., referred to as a “base feature map,” if coming from early exit gate model 124) or the intermediate feature map (e.g., 118A, 118B) from one of early exit gate models 120, 122. In some aspects, though the illustrated example depicts the exit gate model 124 receiving input from the last layer of the base model 110, the final layer of the base model 110 may actually correspond to the penultimate layer of the base model. In some such aspects, these features can be processed using a final layer or component (e.g., a fully connected layer), if the early exit gate model 124 determines not to use the router model 130. Based on these input features, the router model 130 may assign the input data 102 to one or more of the expert models 140, 142, and/or 144 based on the probabilities generated by router model 130. In some aspects, routing an input sample to a single expert model (e.g., one of the expert models 140, 142, and 144) reduces the computation costs and communication overhead. In some aspects, the router model 130 relies on a per-sample routing mechanism that allows the expert models 140, 142, and 144 to specialize in different partitions of the input space, rather than a per-class routing mechanism as is used in at least some conventional MoE architectures.

In some aspects, the router model 130 may be implemented using a single linear layer that takes as an input a flat (e.g., one-dimensional) vector, such as a pre-logit. In alternative aspects, the router model 130 may include additional layers, such as one or more convolutional layers, and may take as input multidimensional (e.g., 2D) feature maps. In some such aspects, the additional layer(s) may reduce the multidimensional feature map to a flat vector for input into a linear layer.

In some examples, the router model 130 may implement a thresholding technique for selecting an expert model (e.g., expert model 140, 142, or 144) based on a simple thresholding rule for the output probabilities of the router model 130. Intuitively, if two expert models have equally high weights (e.g., equally high probabilities generated by the router model 130), then these expert models may both be relevant to a current sample. However, if all experts have a low weight, then the sample may be interpreted as hard or difficult to route, and therefore likely to be misclassified by any chosen expert. In some such cases, an early exit may be a better route through the architecture 100 to avoid unnecessary computations.

Formally, the overall “anytime” model of the architecture 100 may be defined as p^{at-τ} with threshold τ, as the following dynamically weighted ensemble:

$$e e \left(x\right) = 1 \text{iff} ∀ k ∈ \left[1 , K\right] , r \left(k \vert x\right) < τ \qquad \text{(2)}$$

$$\begin{matrix}{p}^{\text{at} - τ} \left(y \vert x\right) = e e \left(x\right) ϕ \left(x\right) + \left(1 - e e \left(x\right)\right) {\sum }_{k = 1}^{K} r \left(k \vert x\right) \left[\left|r \left(k \vert x\right) \geq \right)\right) \\ \left(\left(τ\right|\right] {{e}^{′}}_{k} \left(y \vert x\right)\end{matrix} \qquad \text{(3)}$$

where [| · |] is the indicator function, and τ ∈ [0,1] is the thresholding parameter.

In some aspects, the previously described anytime model is only able to early exit “hard” samples (e.g., ones which are difficult to route). However, from a computational perspective, it may also be beneficial to early exit “easy” samples (e.g., those which are already correctly and confidently classified by base model 110) because such samples do not need to be refined by one of expert models 140, 142, and 144.

In some aspects, the router model 130 does not provide a simple signal for isolating such “easy” samples, but the base model 110 does, because such early exiting may be equivalent to simply using predictions of the base model 110 as output, without using any expert model. Hence, in some aspects, a threshold can be used on those outputs of the base model 110 to identify input data 102 (e.g., images) that the base model 110 is confident about.

In some aspects, the threshold value is defined manually. While in some aspects a threshold may be set based on a holdout validation set, there are different approaches to thresholding that allow for a model to fit within a given computational budget while generating accurate outputs over a range of difficulties of the input samples. This alleviates validation set overfitting issues that could arise if the threshold is always set based on the validation set performance.

Thus, in the illustrated architecture 100, base model thresholding can be implemented using early exit gate models 120, 122, and 124.

As illustrated, the architecture 100 further includes the expert models 140, 142, and 144 (labeled as expert models 1 through k in FIG. 1). In some aspects, the expert models 140, 142, and 144 may be implemented using neural network models such that eₖ: x → y, where y ∈ ℝ^{n_{y}} is the predicted output vector. In some aspects, the expert models 140, 142, and 144 receive the original input data (e.g., input data 102) as input. In other aspects, the feature map (e.g., 118A, 118B) from the last processed layer of base model 110 (e.g., as determined by early exit gate models 120, 122, and/or 124 in this example) is provided to one or more selected expert models as input.

Compared to at least some conventional MoE architectures (in which the inputs to the expert models are generally taken from the output of a previous layer in the overall architecture), in the architecture 100, the expert models 140, 142, and 144 may operate on raw input features or on intermediate feature maps branched off intermediate layers in the base model 110. This beneficially simplifies the training scheme and model stability, as described further below with respect to the example training scheme.

The architecture 100 further includes one or more ensemble models 150. Generally, the expert models 140, 142, and 144 in the architecture 100 may be trained and specialized to specific portions of a dataset and may therefore perform better in these input data portions. However, despite initializing the experts using pre-trained weights obtained from the entire dataset, in some aspects, the expert models 140, 142, and 144 may perform significantly worse than the base model 110 on the portion(s) of the dataset to which each expert model is not specialized. This may be attributed to the individual expert models modifying parameters that were useful for the out-of-domain samples (samples that are no longer routed to the specific expert) during training. This may pose a risk in some aspects, as relying exclusively on the expert model selection of the router model 130 can significantly reduce the performance of the overall architecture 100 in the case of routing errors. In some aspects, to ameliorate or overcome this problem, the architecture 100 can implement model ensembling.

In at least some conventional MoE architectures, ensembling may be used at the expert level, where the predictions of one or more expert models (e.g., the top t experts) are combined for improved performance. However, this conventional ensembling of the experts provides little benefit while significantly increasing the computational costs. Accordingly, as illustrated, the architecture 100 ensembles the prediction of the selected expert model (e.g., from expert model 140, 142, or 144 in this example), which may be referred to as the “specific knowledge branch,” with the predictions of the base model 110, which as above may be referred to as the generic or “shared knowledge branch.”

The ensemble model 150 ultimately generates output data 104 in scenarios in which the expert models are not bypassed, as discussed further with respect to the examples of FIGS. 2-4. In some aspects, if the early exit gate model 124 determines to bypass the expert models, then the output data 104 may correspond to the output of the base model 110.

Note that FIG. 1 generally provides an overview of structures and data flows for architecture 100; however, additional details (such as data transformation or shaping layers) may be omitted for clarity and may be added and based on implementation without departing from the scope of the overall framework depicted in FIG. 1.

FIG. 2 depicts an example 200 of processing the input data 102 with the architecture 100 described with respect to FIG. 1. In some aspects, as discussed above, the example 200 may correspond to a workflow performed by a machine learning system, such as the machine learning system that corresponds to, includes, and/or implements the architecture 100.

In the example 200, the input data 102 is processed by each layer in the base model 110. After each respective layer of the base model 110 is processed, the output (e.g., an intermediate feature map) is provided to a corresponding early exit gate associated with the respective layer (e.g., the early exit gate model 120 for the layer 112, the early exit gate model 122 for the layer 114, and so on) to determine whether to early exit the base model 110. As discussed, in some aspects, each early exit gate model 120 and 122 may generally output a binary classification (based on the input intermediate features) indicating whether to perform the early exit. In this example, none of the early exit gate models (e.g., early exit gate models 120, 122) result in early exiting the base model 110. This may be because, for example, predictions based on the intermediate feature maps (as assessed by the early exit gate models 120 and 122) are not sufficiently confident to warrant early exit (e.g., above a threshold). In this example, when a base model early exit gate (e.g., the early exit gate model 120 or 122) determines not to exit, the input feature map (provided to the early exit gate model) is provided to the next or subsequent layer of the base model 110. In some aspects, the early exit gate model itself provides the features to the next layer of the base model 110. In other aspects, the base model early exit gates may provide a signal (e.g., a binary signal), which then causes the intermediate feature map from the previous layer to be provided to the next layer in base model 110.

As depicted, the base model 110 is fully processed in this example, and output from the base model 110 is processed by the early exit gate model 124. As used herein, the base model 110 may be referred to as “fully processed” to indicate that data was passed at least through the penultimate layer of the base model 110, where the final processing (e.g., a final fully connected or classification layer) may be implemented as a separate component. In this example, the output from base model 110 provided to the early exit gate model 124 may be referred to as a “base feature map” 202, which may be a feature map from a penultimate or final layer of the base model 110, such as before the final fully connected or classification layer of the base model 110.

As discussed above, the early exit gate model 124 may generally be used to determine whether to pass the base feature map 202 to the router model 130 or to the output (e.g., to the final layer of the base model 110). In the illustrated example, the early exit gate model 124 determines to provide output from the base model 110 to the router model 130 and the ensemble model 150. In some aspects, the output provided by the early exit gate model 124 is the base feature map 202, as discussed above. In other aspects, the output of the early exit gate model 124 may be a control signal (e.g., a binary signal) that causes the base feature map 202 to be selectively provided to the ensemble model 150 and the router model 130.

In this example, the router model 130 receives the output from the base model 110 (e.g., a final feature map generated by the base model 110) as input from the early exit gate model 124. The router model 130 processes the output feature map to select one of the expert models 140, 142, and 144. In the illustrated example, the expert model 142 is selected to process the base feature map 202. The output of expert model 142 is then provided to the ensemble model 150. In this example, the output of the expert model 142 may be another feature map (e.g., rather than a classification or other discrete output), indicated as expert feature map 204 in FIG. 2.

Further in the depicted example, the ensemble model 150 processes output from the base model 110 (e.g., the base feature map 202 in this example) and the output of the selected expert model 142 (e.g., expert feature map 204 in this example) to generate output data 104. The particular content and nature of the output data 104 may vary, depending on the particular implementation and task. For example, the output data 104 may correspond to a discrete task output such as (but not limited to) a classification, object detection, image segmentation, a range of probabilities related to a range of classes for classification, or the like. In some aspects, the input data 102 comprises image data. In some aspects, as discussed above, the output data 104 may be processed using a final layer or component (e.g., a fully connected layer or classifier) to generate the desired output prediction. In some aspects, the output data 104 comprises an image classification, object detection output, image segmentation output, or the like.

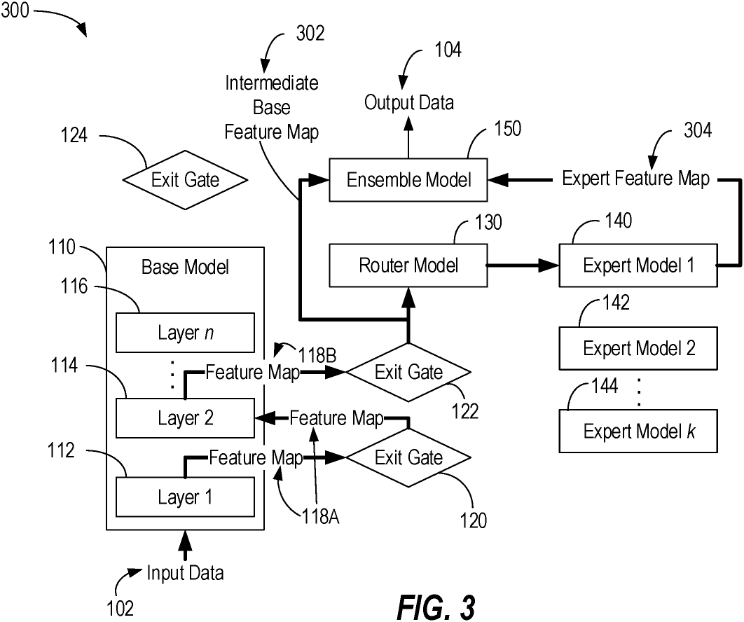

FIG. 3 depicts another example 300 of processing input data 102 with the architecture 100 described with respect to FIG. 1. In some aspects, as discussed above, the example 300 may correspond to a workflow performed by a machine learning system, such as the machine learning system that corresponds to, includes, and/or implements the architecture 100.

In the example 300, the input data 102 is processed by only a subset of layers in the base model 110. Unlike the example of FIG. 2, in the depicted example of FIG. 3, one of the early exit gate models (here, the early exit gate model 122) determines to exit processing by the base model 110. This may be, for example, because the early exit gate model 122 determines that the intermediate feature map 118B has a high probability of generating a confident inference by one of the expert models 140, 142, and 144 (which is learned through training).

Accordingly, the intermediate feature map 118B may be used and/or transformed into an intermediate base feature map 302, and the intermediate base feature map 302 is provided as input to the router model 130 and the ensemble model 150. That is, the intermediate feature map 118B (generated by layer 114 of the base model 110) may be referred to as the intermediate base feature map 302 to indicate that it is the output of the base model 110 during the depicted workflow (e.g., because the early exit gate model 122 determined to exit processing by the base model 110).

In this example, the router model 130 receives the output from an internal layer of the base model 110 (e.g., an intermediate feature map 118A/intermediate base feature map 302 generated by the base model 110) as input from early exit gate model 122. The router model 130 processes the intermediate feature map to select one of the expert models 140, 142, and 144. In the illustrated example, the expert model 140 is selected to process the intermediate base feature map 302, and the output (expert feature map 304) of the expert model 140 is then provided to the ensemble model 150. In this example, the output of the expert model 140 is another feature map (e.g., rather than a classification or other discrete output) indicated as expert feature map 304 in FIG. 3.

The ensemble model 150 then processes output from the base model 110 (intermediate base feature map 302 in this example) and the output of the expert model 140 (expert feature map 304 in this example) to generate output data 104. The output data 104 may be, for example, a discrete output like a classification, or a range of probabilities related to a range of classes for classification, or the like.

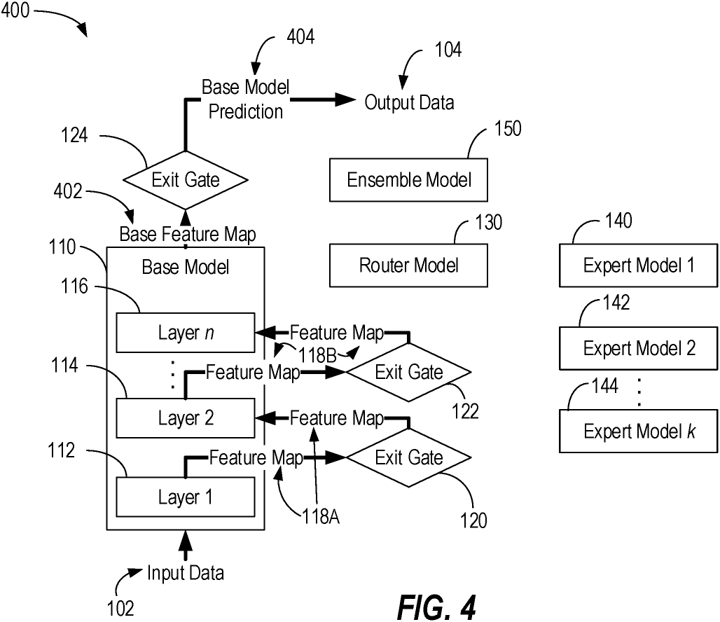

FIG. 4 depicts another example 400 of processing input data 102 with the the architecture 100 described with respect to FIG. 1. In some aspects, as discussed above, the example 400 may correspond to a workflow performed by a machine learning system, such as the machine learning system that corresponds to, includes, and/or implements the architecture 100.

In the example 400, the input data 102 is again processed by each layer in the base model 110. As with the example of FIG. 2, in this example, none of the early exit gate models (e.g., the early exit gate models 120, 122) result in early exiting the base model 110, and a base feature map 402 is then provided to the early exit gate model 124.

Unlike the example in FIG. 2, in the illustrated example of FIG. 4, the early exit gate model 124 determines to exit without utilizing the router model 130, the expert models 140, 142, and 144, or the ensemble model 150. This may be because, for example, the early exit gate model 124 determines that the prediction made by the base model 110 is sufficiently confident and that further processing is unneeded. This early exit, without further processing, thus allows significant additional processing by the router model 130, one or more selected expert models, and the ensemble model 150 to be avoided.

The early exit gate model 124 thus provides base model prediction 404 as output data 104. In some aspects, as discussed above, the early exit gate model 124 may receive base feature map 402 and/or the base model prediction 404 from the base model 110, and output the base feature map 402 to the router model 130 and the ensemble model 150 when the early exit gate model 124 determines not to early exit (such as in the examples of FIGS. 2 and 3), or to provide the base model prediction 404 as output when the early exit gate model 124 determines to early exit, as in the example of FIG. 4.

In other aspects, a final task output layer (e.g., a classification layer), not depicted in FIG. 4, may process the base feature map 402 to generate the output data 104. In other aspects, early exit gate model 124 may provide a signal, such as (but not limited to) a binary signal, which causes either the base feature map 402 to be provided to the router model 130 and the ensemble model 150, such as in the examples of FIGS. 2 and 3, or to provide the base model prediction 404 as output data 104 when the early exit gate model 124 determines to early exit, as in the example of FIG. 4.

### Training Procedure

In some aspects, an asynchronous and easily parallelizable training scheme, in which a router model (e.g., router model 130 in FIGS. 1-4) and expert models (e.g., expert models 140, 142, and 144 in FIGS. 1-4) are trained independently following the objective in Expression 1, may be used. In order to initialize the router model, the pre-trained base model’s embeddings may be clustered using a technique, such as (but not limited to) K-means.

Training aspects described herein address two training pitfalls more specific to neural networks. A first issue stems from calibration issues in convolutional neural networks. For example, training the ensemble model (e.g., ensemble model 150 in FIGS. 1-4) jointly with the expert models (e.g., expert models 140, 142, and 144) may lead to the ensemble model heavily favoring the base model, preventing the expert models from specializing. This may be due to the base model being overly confident on many training samples. This may be particularly apparent on small datasets where the base model is already close to perfectly fitting the training set. To avoid this problem, in some aspects, the ensemble model may be trained after fully training the expert models.

A second issue stems from the trade-off between the expert models’ specialization and potential routing errors by a router model (e.g., router model 130), which is related to so-called catastrophic forgetting behaviors. In other words, because expert models are trained on a subset of the data (e.g., the clusters discussed above), the expert models might “forget” classes of data the expert models never see during training. While the ensemble model does alleviate this problem to some extent, on small-scale datasets, it may be beneficial to route additional negative samples, albeit with a lower weight, to the expert models during training. More specifically, during training of the expert models, the router model r in Expression 1 is “smoothed” using the transformation Γ: x ↦ clip(x, γ, 1), where Γ is the smoothing function, γ is a hyperparameter, and x corresponds to the output of the router model, which is fed to the smoothing function. For example, γ = 0.05 may be used in one example. In some aspects, in addition to or instead of smoothing the output of the router model during training, the router model output is used as sampling probabilities when forming the training batch(es) for each expert model.

Accordingly, a training pipeline may be configured as follows.

First, train the base model ϕ (e.g., base model 110) on a dataset, D, or use an off-the-shelf pre-trained base model.

Second, define the initial router model r₀ (e.g., router model 130) by clustering the input training data. As above, K-means may be used with hard cluster assignments on the base model’s pre-logits.

Third, train the router model, r, to match r₀ by minimizing their Kullback-Leibler (KL) divergence. That is, the router model can be trained to minimize the KL divergence between the output of the router model and the set of training subsets generated by clustering the input data. In some aspects, the router model can further be trained based on the expert model having the lowest task loss (e.g., the most accurate expert model for each data sample). For example, the system may identify the most accurate expert model (with the lowest task-specific loss), and compute cross-entropy loss between the router output (e.g., the selected expert) and the determined best expert. This may further be used to refine the router.

Fourth, train each expert eₖ (e.g., expert models 140, 142, and) using the smoothed initial gate Γ o r₀(k| ·) according to Expression 1. Then train the ensemble model d (e.g., ensemble model 150) using the same objective. Note that in an alternative configuration where multiple ensemble models are used, such as one ensemble model per expert model, then this step would train each ensemble model dₖ using the same objective

Note that the third and fourth steps are independent from one another. Thus, the router model and the expert models can be trained in parallel, which provides an efficiency gain compared to at least some conventional end-to-end methods.

### A Joint Training Scheme for the Router and Experts

The architecture 100 of FIGS. 1-4 contains multiple inter-dependent trainable components, including the router model r (e.g., router model 130), the expert models {eₖ}_{1...K} (e.g., expert models 140, 142, and 144), the early exit gates (e.g., early exit gate models 120, 122, and 124), and an ensemble model d (e.g., ensemble model 150) (or in other aspects, each expert’s respective ensembling module, {dₖ}_{1...K}). An example objective goal is to maximize the total likelihood from Expression 1.

In some aspects, the training scheme may be extended to jointly training the router model and the expert models. A difficulty to training these models jointly lies in the “chicken-and-egg” dependency between the router model and the expert models. One technique to address this issue is to use the Expectation Maximization (EM) algorithm, treating the router model weights as latent variables. Deriving the EM algorithm in the current setting yields Expressions 4 and 5 below. Specifically, Expression 4 depicts the “E step” (e.g., the expectation step), while Expression 5 depicts the “M step” (e.g., the maximization step). In Equation 4, for all (x, y), the posterior is updated as below, where x is the input data, y is the associated ground-truth for the input data q(k|x) is the posterior value to be updated, r(k|x) is the output of the router model (e.g., the probability that input x is routed to expert model k), r(k′|x) corresponds to the probability that the input is routed to expert model k′,

$${{e}^{′}}_{k} \left(y \vert x\right)$$

is the output of expert model k (with ensembling) for input x, and

$${{e}^{′}}_{{k}^{′}} \left(y \vert x\right)$$

is the output of the expert model k′ (with ensembling) for the input.

$$q \left(k \vert x\right) ← \frac{r \left(k \vert x\right) {{e}^{′}}_{k} \left(y \vert x\right)}{{\sum }_{{k}^{′}} r \left({k}^{′} \vert x\right) {{e}^{′}}_{{k}^{′}} \left(y \vert x\right)} \qquad \text{(4)}$$

Additionally, in the M step, the system can train r and all

$${{e}^{′}}_{k}$$

with the following objective (to minimize), where x is the input data with associated ground-truth y, r(k|x) is the output of the router model (e.g., the probability that sample x is routed to expert k), q(k|x) is the posterior that the router model is trained to match (e.g., given by Equation 4 above), e′k(y | x) is the output of the expert model k, KL refers to the Kullback-Leibler divergence, and e′ₖ is the expectation function).

$$L = {E}_{\left(x , y\right) \sim D} \left(\text{KL} \left(q \left(k \vert x\right) , r \left(k \vert x\right)\right) - {\sum }_{k = 1}^{K} q \left(k \vert x\right) log {{e}^{′}}_{k} \left(y \vert x\right)\right) \qquad \text{(5)}$$

In other words, the EM algorithm alternates between the E step, computing the projected router model weights updated based on the current expert models’ performances, and the M step, separately training the expert models according to this new assignment (e.g., the posterior given by Equation 4), indicated by the right-hand term, while forcing the router model to also match the new assignment, indicated by the lefthand term.

### Example Method for Processing Data Using a Model Architecture

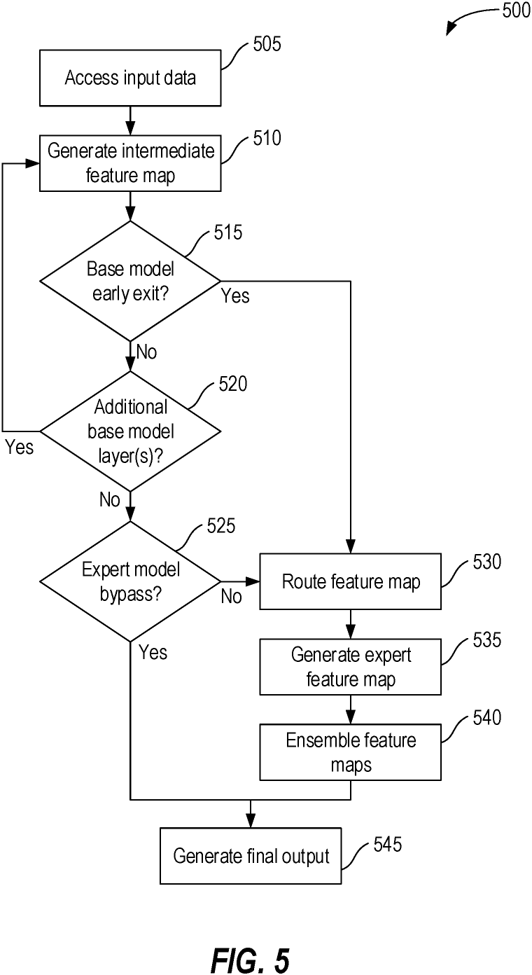

FIG. 5 depicts an example method 500 to process data using a model architecture, such as described above with respect to FIGS. 1-4. In some aspects, the method 500 is performed by a system, such as the machine learning system that corresponds to, includes, and/or implements architecture 100 and/or performs the workflows depicted in examples 200, 300, and/or 400.

At block 505, input data (e.g., input data 102 of FIG. 1) is accessed for processing. As discussed above, the particular format and content of the input data 102 may vary depending on the particular implementation. In at least one aspect, the input data 102 comprises image data.

At block 510, the system generates an intermediate feature map (e.g., an intermediate feature map 118 of FIG. 1) based on the input data. For example, as discussed above, the system may process the input data using a first layer of a base model (e.g., base model 110 of FIG. 1) to generate the intermediate feature map.

At block 515, the system determines whether to early exit the base model based on the intermediate feature map (generated at block 510). For example, as discussed above, the system may process the intermediate feature map using an early exit gate model (e.g., early exit gate model 120 of FIG. 1) to determine whether to early exit the base model (e.g., to provide the intermediate feature map to a router model) or to continue processing using the base model.

If, at block 515, the system determines to early exit the base model, then the method 500 continues to block 530, discussed in more detail below. If the system determines not to early exit the base model, then the method 500 continues to block 520, where the system determines whether there is at least one additional layer remaining in the base model. If so, then the method 500 returns to block 510, where the system generates another intermediate feature map (e.g., intermediate feature map 118B) by processing the previously generated intermediate feature map using the next or subsequent layer of the base model.

If, at block 520, the system determines that there are no remaining layers in the base model, then the method 500 continues to block 525, where the system determines whether to bypass the expert model(s) based on the output of the final layer of the base model (e.g., the base feature map 202 of FIG. 2). For example, as discussed above, the system may process the base feature map using an early exit gate or bypass model (e.g., early exit gate model 124) to determine whether to bypass the expert model(s).

If, at block 525, the system determines to bypass the expert models, then the method 500 continues to block 545, discussed in more detail below. If the system determines not to bypass the expert models, then the method 500 continues to block 530.

At block 530, the system routes the feature map (generated using one or more layers of the base model) to one or more expert models. For example, as discussed above, the system may process the feature map (generated by the base model) using a routing model (e.g., router model 130) to select one or more expert models (e.g., expert model 140, 142, or 144).

In an aspect, the specific feature map that is routed to the expert model(s) may vary, depending on the particular execution path followed for the input data. For example, if the system determines (at block 515) to early exit the base model, then the intermediate feature map (generated by an intermediate layer of the base model) may be routed to an expert model. If the system fully processes the base model, then the base model output features may be routed to an expert model.

At block 535, the system generates one or more expert feature map(s) (e.g., expert feature map(s) 204, 304) by processing the routed feature map (e.g., the base feature map or the intermediate feature map) using the expert model(s) selected at block 530.

At block 540, the system can then ensemble the generated expert feature map(s) with the base model feature map (generated by the final layer of the base model). For example, as discussed above, an ensemble model (such as the ensemble model 150 of FIG. 1) may be used to combine or aggregate the expert feature map and the base feature map.

At block 545, the system generates final output from the model architecture. Generally, the specific operation(s) used to generate the final output may vary depending on the particular implementation. For example, in some aspects, the features themselves (e.g., the ensembled features generated at block 540, or the base model output features generated by the base model) are directly provided as the architecture output.

In some aspects, the final features (e.g., the base model features or the ensembled features) are processed with a final layer or component (e.g., a fully connected layer or a classifier layer) to generate the model architecture output (e.g., to classify the input data, to provide image segmentation for the input data, and the like).

Generally, the method 500 may be used to perform inferencing using the model architecture, as well as training. For example, during inferencing, the final output (generated at block 545) may be returned as the output of the architecture. In some aspects, during training, the output may be compared against a label or ground truth in order to generate one or more loss terms that can be used to refine the various model components, as discussed above.

In at least one aspect, rather than training the entire architecture end-to-end, the system can train portions of the architecture separately. For example, the system may train the base model using all of the data samples. Additionally, the router model may be trained or generated (e.g., using clustering) based on the input data and/or based on features generated by the base model for each input sample. In some aspects, the system can then use the initially trained router to route each training sample to one or more of the expert models (e.g., to generate subsets of training data). Each subset of the training data can then be used to train a corresponding expert model. Finally, the ensemble model(s) can be trained based on the output of the expert model(s) and the base model.

### Example Method of Inferencing

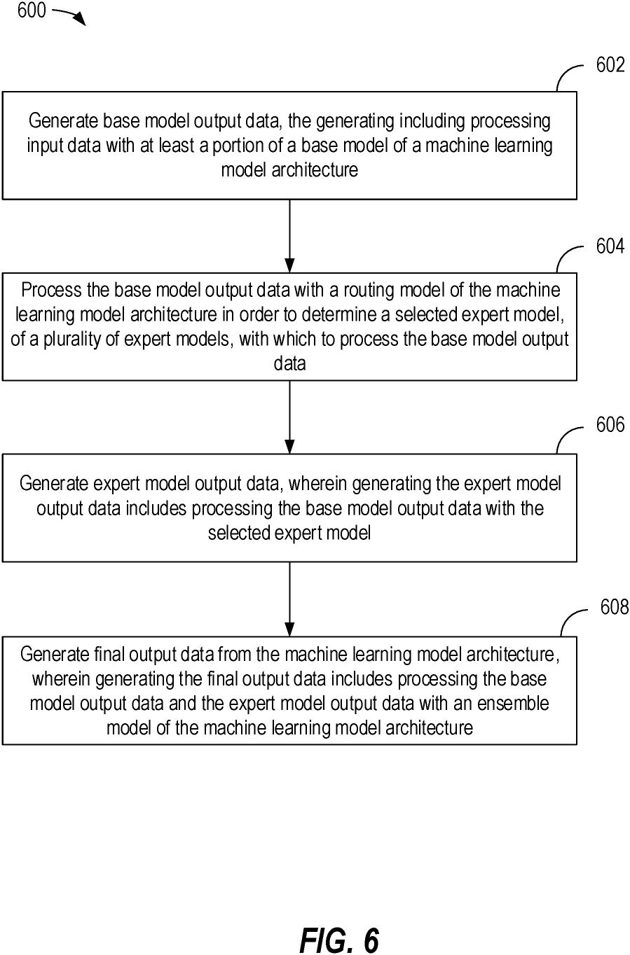

FIG. 6 depicts an example inferencing method 600 that may be performed with a model architecture, such as described above with respect to FIGS. 1-5.

At block 602, base model output data is generated, the generating including processing input data with at least a portion of a base model of a machine learning model architecture.

In some aspects, processing input data with at least a portion of the base model comprises processing intermediate feature data from at least one layer of the base model with a gate model associated with the at least one layer in order to determine whether to early exit the base model.

In some aspects, the method 600 further includes determining not to early exit the base model based on output from the gate model, wherein processing the input data with the at least a portion of the base model comprises processing all layers of the base model to generate the base model output data.

In some aspects, the base model comprises a deep convolutional neural network or a transformer neural network.

At block 604, the base model output data is processed with a routing model of the machine learning model architecture in order to determine a selected expert model, of a plurality of expert models, with which to process the base model output data.

In some aspects, the method 600 further includes determining to early exit the base model based on output from the gate model, wherein the base model output data processed by the routing model comprises the output from the gate model.

In some aspects, the gate model comprises a multi-layer perceptron model.

In some aspects, the routing model comprises a linear layer, a convolutional neural network model, or a multi-layer perceptron model.

At block 606, expert model output data is generated, wherein generating the expert model output data includes processing the base model output data with the selected expert model.

In some aspects, the selected expert model comprises a convolutional neural network model or a transformer model.

At block 608, final output data from the machine learning model architecture is generated, wherein generating the final output data includes processing the base model output data and the expert model output data with an ensemble model of the machine learning model architecture.

In some aspects, the method 600 further includes generating second base model output data, wherein generating the second base model output data includes processing second input data with at least a portion of the base model, processing the second base model output data with a second gate model associated with a final layer of the base model in order to determine whether to process the second base model output data using the routing model, determining not to process the second base model output data using the routing model, and generating second final output data from the machine learning model architecture based on the second base model output data.

In some aspects, generating the second final output data from the machine learning model architecture comprises processing the second base model output data using a fully connected layer.

Note that FIG. 6 is just one example of a method, and other methods including fewer, additional, or alternative steps are possible consistent with this disclosure.

### Example Method of Training

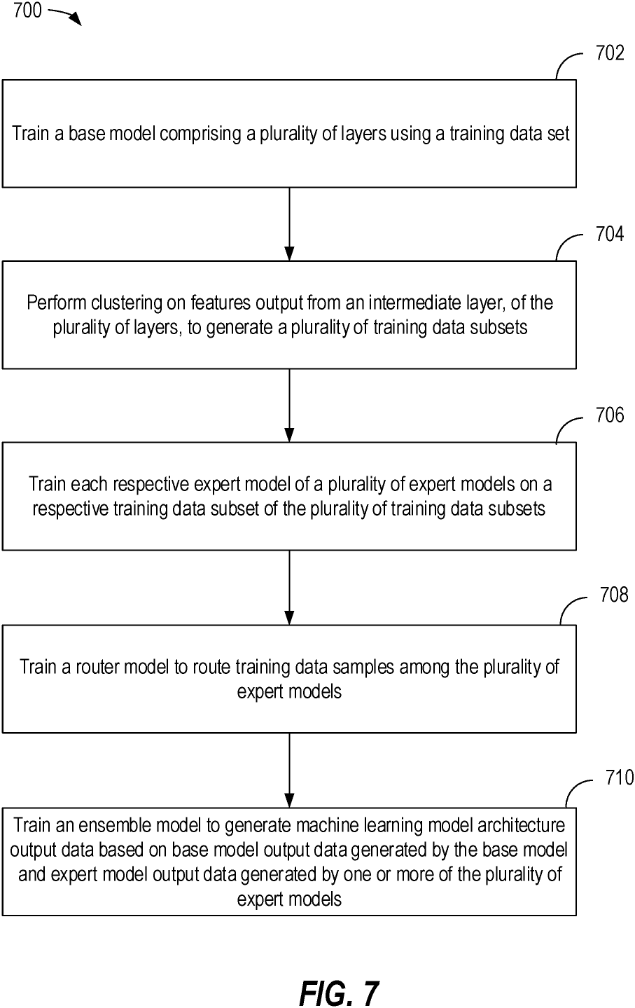

FIG. 7 depicts an example training method 700, which may be used for training a machine learning model architecture, as described above with respect to FIGS. 1-5.

At block 702, a base model comprising a plurality of layers is trained using a training data set.

At block 704, clustering on features output from an intermediate layer, of the plurality of layers, is performed to generate a plurality of training data subsets.

In some aspects, performing clustering on the features output from the intermediate layer of the base model to generate the plurality of training data subsets comprises performing K-means clustering on the features output from the intermediate layer of the base model.

In some aspects, the K-means clustering generates a number of clusters K that is equal to a number of expert models in the plurality of expert models.

At block 706, each respective expert model of a plurality of expert models is trained on a respective training data subset of the plurality of training data subsets.

At block 708, a router model is trained to route training data samples among the plurality of expert models.

In some aspects, training the router model to route the training data samples among the plurality of expert models comprises minimizing a first loss component based on the plurality of training data subsets generated by the clustering and output from the router model.

In some aspects, training the router model to route the training data samples among the plurality of expert models further comprises minimizing a second loss component based on the output from the router model and an output from the expert model of the plurality of expert models with a lowest task loss.

In some aspects, the first loss component comprises a Kullback-Leibler divergence loss.

In some aspects, the second loss component comprises a cross-entropy loss.

At block 710, an ensemble model is trained to generate machine learning model architecture output data based on base model output data generated by the base model and expert model output data generated by one or more of the plurality of expert models.

In some aspects, the method 700 further includes training one or more gate models to minimize a task loss based on the machine learning model architecture output data.

Note that FIG. 7 is just one example of a method, and other methods including fewer, additional, or alternative steps are possible consistent with this disclosure.

### Example Processing Device

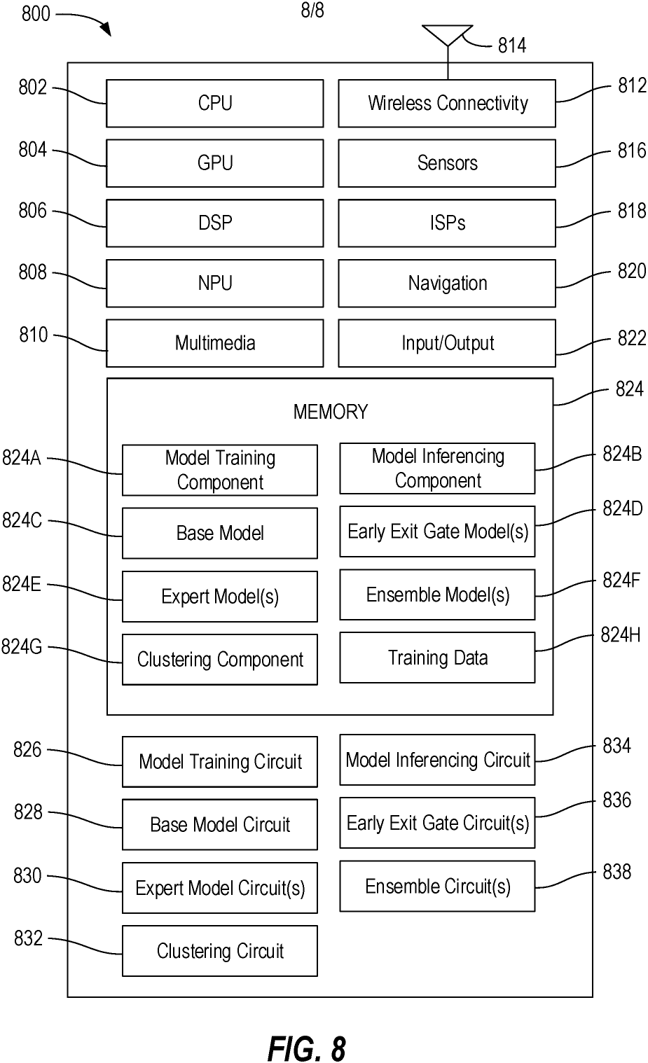

FIG. 8 depicts an example processing system configured to perform the various methods described herein, for example with respect to FIGS. 1-7.

Processing system 800 includes a central processing unit (CPU) 802, which in some examples may be a multi-core CPU. Instructions executed at the CPU 802 may be loaded, for example, from a program memory associated with the CPU 802 or may be loaded from a partition of memory 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error. In some cases, an NPU may be configured to perform the federated learning methods described herein.

NPUs designed to accelerate inference are generally configured to operate on complete models. Such NPUs may thus be configured to input a new piece of data and rapidly process the data through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814. In some examples, wireless connectivity component 812 allows for performing federated learning according to methods described herein over various wireless data connections, including cellular connections.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes model training component 824A, model inferencing component 824B, base model 824C, early exit gate model(s) 824D, expert model(s) 824E, ensemble model(s) 824F, clustering component 824G, and training data 824H. The depicted components, and others not depicted, may be configured to perform various aspects of the methods described herein.

Processing system 800 further comprises model training circuit 826, base model circuit 828, expert model circuit(s) 830, clustering circuit 832, model inferencing circuit 834, early exit gate circuit(s) 836, and ensemble circuit(S) 838. The depicted circuits, and others not depicted, may be configured to perform various aspects of the techniques described herein.

Though depicted as separate components and circuits for clarity in FIG. 8, model training circuit 826, base model circuit 828, expert model circuit(s) 830, clustering circuit 832, model inferencing circuit 834, early exit gate circuit(s) 836, and ensemble circuit(S) 838 may collectively or individually be implemented in other processing devices of processing system 800, such as within CPU 802, GPU 804, DSP 806, NPU 808, and the like.

For example, the model training component 824A and/or model training circuit 826 may be used to train one or more components of the model architecture (e.g., the base model 824C, expert model(s) 824E, clustering component 824G, early exit gate models 824D, and/or ensemble model(s) 824F) using training data 824H, as discussed above. The model inferencing component 824B and/or model inferencing circuit 834 may be used to generate output predictions or features using the model architecture (e.g., the base model 824C, expert model(s) 824E, clustering component 824G, early exit gate models 824D, and/or ensemble model(s) 824F), as discussed above.

The base model 824C and/or base model circuit 828 may correspond to the base model 110 of FIG. 1, and may be used to perform initial (and, in some cases, final) processing of input data, as discussed above. The early exit gate model(s) 824D and/or early exit gate circuit(s) 836 may correspond to the early exit gate models 120, 122, and/or 124 of FIG. 1, and may be used to evaluate base model features (e.g., intermediate features or final base model feature output) to determine whether to early exit the base model and/or to bypass the expert models, as discussed above.

The expert model(s) 824E and/or expert model circuit(s) 830 may correspond to the expert models 140, 142, and/or 144 of FIG. 1, and may be used to provide specialized or additional processing of input data and/or of intermediate or base model features, as discussed above. The ensemble model(s) 824F and/or ensemble circuit(s) 838 may correspond to the ensemble model 150 of FIG. 1, and may be used to ensemble, combine, or otherwise aggregate the output of one or more expert model(s) 824E and the output of the base model 824C, as discussed above.

The clustering component 824G and/or clustering circuit 832 may correspond to the router model 130 of FIG. 1, and may be used to cluster the training data 824H and/or the output(s) of the base model 824C to generate subsets used to train the expert model(s) 824E, and/or may be used to route data samples to one or more expert model(s) 824E, as discussed above.

Generally, processing system 800 and/or components thereof may be configured to perform the methods described herein.

Notably, in other cases, aspects of processing system 800 may be omitted or added. For example, multimedia processing unit 810, wireless connectivity component 812, sensor processing units 816, ISPs 818, and/or navigation processor 820 may be omitted in other aspects. Further, aspects of processing system 800 may be distributed between multiple devices. For example, in some cases training of a model architecture, like the architecture 100 of FIG. 1, may be performed on one device, while inferencing may be performed on a separate device, such as a resource-constrained device.

### Example Clauses

Implementation examples are described in the following numbered clauses.

Clause 1: A computer-implemented method, comprising: generating base model output data, the generating including processing input data with at least a portion of a base model of a machine learning model architecture; processing the base model output data with a routing model of the machine learning model architecture in order to determine a selected expert model of a plurality of expert models with which to process the base model output data; generating expert model output data, wherein generating the expert model output data includes processing the base model output data with the selected expert model; and generating final output data from the machine learning model architecture, wherein generating the final output data includes processing the base model output data and the expert model output data with an ensemble model of the machine learning model architecture.

Clause 2: The method of Claim 1, wherein processing the input data with the at least a portion of the base model comprises processing intermediate feature data from at least one layer of the base model with a gate model associated with the at least one layer in order to determine whether to early exit the base model.

Clause 3: The method of Clause 2, further comprising: determining to early exit the base model based on output from the gate model, wherein the base model output data processed by the routing model comprises the output from the gate model.

Clause 4: The method of Clause 2, further comprising: determining not to early exit the base model based on output from the gate model, wherein the processing input data with the at least a portion of the base model comprises processing all layers of the base model to generate the base model output data.

Clause 5: The method of any of Clauses 1-4, wherein the base model comprises a deep convolutional neural network or a transformer neural network.

Clause 6: The method of any of Clauses 1-5, wherein the router model comprises a linear layer, a convolutional neural network model, or a multi-layer perceptron model.

Clause 7: The method of any of Clauses 1-6, wherein the selected expert model comprises a convolutional neural network model or a transformer model.

Clause 8: The method of any of Clauses 2-7, wherein the gate model comprises a multi-layer perceptron model.

Clause 9: The method of any of Clauses 1-8, wherein the input data comprises image data, and the final output data comprises an image classification.

Clause 10: The method of any of Clauses 1-9, wherein the input data comprises image data, and the final output data comprises an object detection output.

Clause 11: The method of Claim 10, wherein the object detection output comprises a bounding box.

Clause 12: The method of Claim 1, wherein the input data comprises image data, and the final output data comprises an image segmentation output.

Clause 13: A computer-implemented method for training a machine learning model architecture, comprising: training a base model using a training data set; performing clustering on features output from an intermediate layer of the base model to generate a plurality of training data subsets; training each expert model of a plurality of expert models on a training data subset of the plurality of training data subsets; training a router model to route each training data sample to one expert model of the plurality of expert models; and training an ensemble model to generate the machine learning model architecture output data based on base model output data and expert model output data.

Clause 14: The method of Claim 13, wherein training the router model to route each training data sample to one expert model of the plurality of expert models comprises minimizing a first loss component based on the plurality of training data subsets generated by the clustering and output from the router model.

Clause 15: The method of Clause 14, wherein training the router model to route each training data sample to one expert model of the plurality of expert models comprises minimizing a second loss component based on the output from the router model and an output from the expert model of the plurality of expert models with a lowest task loss.

Clause 16: The method of any of Clauses 14-15, wherein the first loss component comprises a Kullback-Leibler divergence loss.

Clause 17: The method of any of Clauses 14-16, wherein the second loss component comprises a cross-entropy loss.

Clause 18: The method of any of Clauses 13-17, wherein performing the clustering on the features output from the intermediate layer of the base model to generate the plurality of training data subsets comprises performing K-means clustering on the features output from the intermediate layer of the base model.

Clause 19: The method of Clause 18, wherein the K-means clustering generates a number of clusters K that is equal to a number of expert models in the plurality of expert models.

Clause 20: The method of any of Clauses 13-19, further comprising training the one or more gate models to minimize a task loss based on the machine learning model architecture output data.

Clause 21: The method of any of Clauses 13-20, wherein the machine learning model architecture comprises: the base model comprising a plurality of layers and configured to generated based model output data base on at least a portion of the base model; the one or more gate models configured to base model output data from a layer of the plurality of layers of the base model and to determine whether to exit the base model early; the router model configured to receive the base model output data and to select an expert model of the plurality of expert models with which to process the base model output data; and the ensemble model configured to process the base model output data and expert model output data from a selected expert model to generate the machine learning model architecture output data.

Clause 22: A method, comprising: generating base model output data by processing input data with at least a portion of a base model of a machine learning model architecture; processing the base model output data with a routing model of the machine learning model architecture in order to determine a selected expert model, of a plurality of expert models, with which to process the base model output data; generating expert model output data by processing the base model output data with the selected expert model; and generating final output data from the machine learning model architecture by processing the base model output data and the expert model output data with an ensemble model of the machine learning model architecture.

Clause 23: The method of Clause 22, wherein processing the input data with the at least a portion of the base model comprises processing intermediate feature data from at least one layer of the base model with a gate model associated with the at least one layer in order to determine whether to early exit the base model.

Clause 24: The method of any of Clauses 22-23, further comprising: determining to early exit the base model based on output from the gate model, wherein the base model output data processed by the routing model comprises the output from the gate model.

Clause 25: The method of any of Clauses 22-24, further comprising: determining not to early exit the base model based on output from the gate model, wherein processing the input data with the at least a portion of the base model comprises processing all layers of the base model to generate the base model output data.

Clause 26: The method of any of Clauses 22-25, wherein the gate model comprises a multi-layer perceptron model.

Clause 27: The method of any of Clauses 22-26, wherein the base model comprises a deep convolutional neural network or a transformer neural network.

Clause 28: The method of any of Clauses 22-27, wherein the routing model comprises a linear layer, a convolutional neural network model, or a multi-layer perceptron model.

Clause 29: The method of any of Clauses 22-28, wherein the selected expert model comprises a convolutional neural network model or a transformer model.

Clause 30: The method of any of Clauses 22-29, further comprising: generating second base model output data, wherein generating the second base model output data includes processing second input data with at least a portion of the base model; processing the second base model output data with a second gate model associated with a final layer of the base model in order to determine whether to process the second base model output data using the routing model; determining not to process the second base model output data using the routing model; and generating second final output data from the machine learning model architecture based on the second base model output data.

Clause 31: The method of any of Clauses 22-30, wherein generating the second final output data from the machine learning model architecture comprises processing the second base model output data using a fully connected layer.

Clause 32: A method, comprising: training a base model comprising a plurality of layers using a training data set; performing clustering on features output from an intermediate layer, of the plurality of layers, to generate a plurality of training data subsets; training each respective expert model of a plurality of expert models on a respective training data subset of the plurality of training data subsets; training a router model to route training data samples among the plurality of expert models; and training an ensemble model to generate machine learning model architecture output data based on base model output data generated by the base model and expert model output data generated by one or more of the plurality of expert models.

Clause 33: The method of Clause 32, wherein training the router model to route the training data samples among the plurality of expert models comprises minimizing a first loss component based on the plurality of training data subsets generated by the clustering and output from the router model.

Clause 34: The method of any of Clauses 32-33, wherein training the router model to route the training data samples among the plurality of expert models further comprises minimizing a second loss component based on the output from the router model and an output from the expert model of the plurality of expert models with a lowest task loss.

Clause 35: The method of any of Clauses 32-34, wherein the first loss component comprises a Kullback-Leibler divergence loss.

Clause 36: The method of any of Clauses 32-35, wherein the second loss component comprises a cross-entropy loss.

Clause 37: The method of any of Clauses 32-36, wherein performing the clustering on the features output from the intermediate layer of the base model to generate the plurality of training data subsets comprises performing K-means clustering on the features output from the intermediate layer of the base model.

Clause 38: The method of any of Clauses 32-37, wherein the K-means clustering generates a number of clusters K that is equal to a number of expert models in the plurality of expert models.

Clause 39: The method of any of Clauses 32-38, further comprising training one or more gate models to minimize a task loss based on the machine learning model architecture output data.

Clause 40: A processing system, comprising: a memory comprising computer-executable instructions; and one or more processors configured to execute the computer-executable instructions and cause the processing system to perform a method in accordance with any of Clauses 1-39.

Clause 41: A processing system, comprising means for performing a method in accordance with any of Clauses 1-39.

Clause 42: A non-transitory computer-readable medium comprising computer-executable instructions that, when executed by one or more processors of a processing system, cause the processing system to perform a method in accordance with any of Clauses 1-39.

Clause 43: A computer program product embodied on a computer-readable storage medium comprising code for performing a method in accordance with any of Clauses 1-39.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
generating base model output data, the generating including processing input data with at least a portion of a base model of a machine learning model architecture;
processing the base model output data with a routing model of the machine learning model architecture in order to determine a selected expert model, of a plurality of expert models, with which to process the base model output data;
generating expert model output data, wherein generating the expert model output data includes processing the base model output data with the selected expert model; and
generating final output data from the machine learning model architecture, wherein generating the final output data includes processing the base model output data and the expert model output data with an ensemble model of the machine learning model architecture.

2. The computer-implemented method of claim 1, wherein processing the input data with the at least a portion of the base model comprises processing intermediate feature data from at least one layer of the base model with a gate model associated with the at least one layer in order to determine whether to early exit the base model.

3. The computer-implemented method of claim 2, further comprising determining to early exit the base model based on output from the gate model, wherein the base model output data processed by the routing model comprises the output from the gate model.

4. The computer-implemented method of claim 2, further comprising determining not to early exit the base model based on output from the gate model, wherein processing the input data with the at least a portion of the base model comprises processing all layers of the base model to generate the base model output data.

5. The computer-implemented method of claim 2, wherein the gate model comprises a multi-layer perceptron model.

6. The computer-implemented method of claim 1, wherein the base model comprises a deep convolutional neural network or a transformer neural network.

7. The computer-implemented method of claim 1, wherein the routing model comprises a linear layer, a convolutional neural network model, or a multi-layer perceptron model.

8. The computer-implemented method of claim 1, wherein the selected expert model comprises a convolutional neural network model or a transformer model.

9. The computer-implemented method of claim 1, further comprising:
generating second base model output data, wherein generating the second base model output data includes processing second input data with at least a portion of the base model;
processing the second base model output data with a second gate model associated with a final layer of the base model in order to determine whether to process the second base model output data using the routing model;
determining not to process the second base model output data using the routing model; and
generating second final output data from the machine learning model architecture based on the second base model output data.

10. The computer-implemented method of claim 9, wherein generating the second final output data from the machine learning model architecture comprises processing the second base model output data using a fully connected layer.

11. A computer-implemented method for training a machine learning model architecture, comprising:
training a base model comprising a plurality of layers using a training data set;
performing clustering on features output from an intermediate layer, of the plurality of layers, to generate a plurality of training data subsets;
training each respective expert model of a plurality of expert models on a respective training data subset of the plurality of training data subsets;
training a router model to route training data samples among the plurality of expert models; and
training an ensemble model to generate machine learning model architecture output data based on base model output data generated by the base model and expert model output data generated by one or more of the plurality of expert models.

12. The computer-implemented method of claim 11, wherein training the router model to route the training data samples among the plurality of expert models comprises minimizing a first loss component based on the plurality of training data subsets generated by the clustering and output from the router model.

13. The computer-implemented method of claim 12, wherein training the router model to route the training data samples among the plurality of expert models further comprises minimizing a second loss component based on the output from the router model and an output from the expert model of the plurality of expert models with a lowest task loss.

14. The computer-implemented method of claim 13, wherein the first loss component comprises a Kullback-Leibler divergence loss.

15. The computer-implemented method of claim 14, wherein the second loss component comprises a cross-entropy loss.

16. The computer-implemented method of claim 11, wherein performing the clustering on the features output from the intermediate layer of the base model to generate the plurality of training data subsets comprises performing K-means clustering on the features output from the intermediate layer of the base model.

17. The computer-implemented method of claim 16, wherein the K-means clustering generates a number of clusters K that is equal to a number of expert models in the plurality of expert models.

18. The computer-implemented method of claim 11, further comprising training one or more gate models to minimize a task loss based on the machine learning model architecture output data.

19. A processing system, comprising:
a memory comprising computer-executable instructions; and
one or more processors configured to execute the computer-executable instructions and cause the processing system to perform an operation comprising:
generating base model output data, the generating including processing input data with at least a portion of a base model of a machine learning model architecture;
processing the base model output data with a routing model of the machine learning model architecture in order to determine a selected expert model, of a plurality of expert models, with which to process the base model output data;
generating expert model output data, wherein generating the expert model output data includes processing the base model output data with the selected expert model; and
generating final output data from the machine learning model architecture, wherein generating the final output data includes processing the base model output data and the expert model output data with an ensemble model of the machine learning model architecture.

20. The processing system of claim 19, wherein processing the input data with the at least the portion of the base model comprises processing intermediate feature data from at least one layer of the base model with a gate model associated with the at least one layer in order to determine whether to early exit the base model.

21. The processing system of claim 20, the operation further comprising determining to early exit the base model based on output from the gate model, wherein the base model output data processed by the routing model comprises the output from the gate model.

22. The processing system of claim 20, the operation further comprising determining not to early exit the base model based on output from the gate model, wherein processing the input data with the at least the portion of the base model comprises processing all layers of the base model to generate the base model output data.

23. The processing system of claim 20, wherein the gate model comprises a multi-layer perceptron model.

24. The processing system of claim 19, wherein the base model comprises a deep convolutional neural network or a transformer neural network.

25. The processing system of claim 19, wherein the routing model comprises a linear layer, a convolutional neural network model, or a multi-layer perceptron model.

26. The processing system of claim 19, wherein the selected expert model comprises a convolutional neural network model or a transformer model.

27. The processing system of claim 19, the operation further comprising:
generating second base model output data, wherein generating the second base model output data includes processing second input data with at least a portion of the base model;
processing the second base model output data with a second gate model associated with a final layer of the base model in order to determine whether to process the second base model output data using the routing model;
determining not to process the second base model output data using the routing model; and
generating second final output data from the machine learning model architecture based on the second base model output data.

28. The processing system of claim 27, wherein generating the second final output data from the machine learning model architecture comprises processing the second base model output data using a fully connected layer.

29. A processing system, comprising:
means for generating base model output data, the means for generating the base model output data being configured to process input data with at least a portion of a base model of a machine learning model architecture;
means for processing the base model output data with a routing model of the machine learning model architecture in order to determine a selected expert model, of a plurality of expert models, with which to process the base model output data;
means for generating expert model output data, the means for generating the expert model output data being configured to process the base model output data with the selected expert model; and
means for generating final output data from the machine learning model architecture, the means for generating the final output data being configured to process the base model output data and the expert model output data with an ensemble model of the machine learning model architecture.

30. The processing system of claim 29, further comprising:
means for generating second base model output data, the means for generating the second base model output data being configured to process second input data with at least a portion of the base model;
means for processing the second base model output data with a gate model associated with a final layer of the base model in order to determine whether to process the second base model output data using the routing model;
means for determining not to process the second base model output data using the routing model; and
means for generating second final output data from the machine learning model architecture based on the second base model output data.
